(19) United States
(12) Patent Application Publication
(10) Pub. No.: US 2009/0229603 A1
(43) Pub. Date: Sep. 17, 2009

(54) Protective Garment Usable with Gas Tank Releasibly Carried by Shoulder Straps and Waist Belt

(75) Inventors: William Grilliot, West Milton, OH (US); Thomas Stachler, Brookville, OH (US); Mary Grilliot, West Milton, OH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown (US)

(21) Appl. No.: 12/427,871

(22) Filed: Apr. 22, 2009

Related U.S. Application Data
(63) Continuation-in-part of application No. 12/075,687, filed on Mar. 13, 2008.
Application No. 12/075,687 is a continuation-in-part of application No. 12/242,262, filed on Sep. 30, 2008.

(51) Int. Cl. A62B 7/00; A41D 3/02

(52) U.S. Cl. 128/202.19; 128/205.22; 2/93

(57) ABSTRACT

A system is provided for a firefighter or other emergency worker and includes a protective coat and a self-contained breathing apparatus. The self-contained breathing apparatus includes a regulator connected by a high-pressure hose to a gas tank that is releasibly carried on the coat by shoulder straps and waist straps.

### CROSS-REFERENCE TO RELATED APPLICATION

This application is a C-I-P of two prior applications: U.S. application Ser. No. 12/075,687 filed Mar. 13, 2008 entitled “Protective Garment Adapted for Self-Contained Breathing Apparatus” and U.S. application Ser. No. 12/242,262 filed Sep. 30, 2008 entitled “Breathing Apparatus with Sensor”, both incorporated herein by reference.

### FIELD OF THE INVENTION

The invention relates to protective garments worn by firefighters and other emergency workers and to self-contained breathing apparatus (SCBA) that are used by firefighters and other emergency workers.

### BACKGROUND OF THE INVENTION

It is common for firefighters and other emergency workers to wear a self-contained breathing apparatus (SCBA) which has a cylindrical air tank that is carried on the back of a firefighter by a framework, a harness that will typically include shoulder straps, and a waist strap worn over the coat of their turnout gear. Such tanks are disadvantageous in that being cylindrical, they protrude from the back of the user.

### BRIEF DESCRIPTION OF THE DRAWINGS

FIG. 1A is a perspective view from the side of a fireman or other emergency worker wearing a protective coat and SCBA system embodying the present invention;

FIG. 1B is a fragmentary front elevational view of releasible connectors carried on the coat of FIG. 1;

FIG. 2 is an elevation view of an oxygen/air tank of the SCBA of FIG. 1;

FIG. 3 is a side view of the oxygen/air tank of FIG. 2;

FIG. 4A is a partial front view of the coat of FIG. 1 illustrating engagement of the tank of FIG. 2; and

FIG. 4B is a view of a coat as in FIG. 1 illustrating further details of the engagement of the tank of FIG. 2 with a coat as in FIGS. 1A, 1B.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with one embodiment of the invention, a protective coat and self-contained breathing apparatus system is provided for a firefighter or other emergency worker. The system includes an oxygen/air tank, a regulator, a high pressure hose connected to the tank and the regulator to provide a flow of oxygen/air from the tank to the regulator, and a garment having an outer shell having a torso covering with a back and a front, a pair of sleeves extending from the torso covering portion, and a releasible harness carrying the oxygen/air tank. The harness releasibly engages the outer shell.

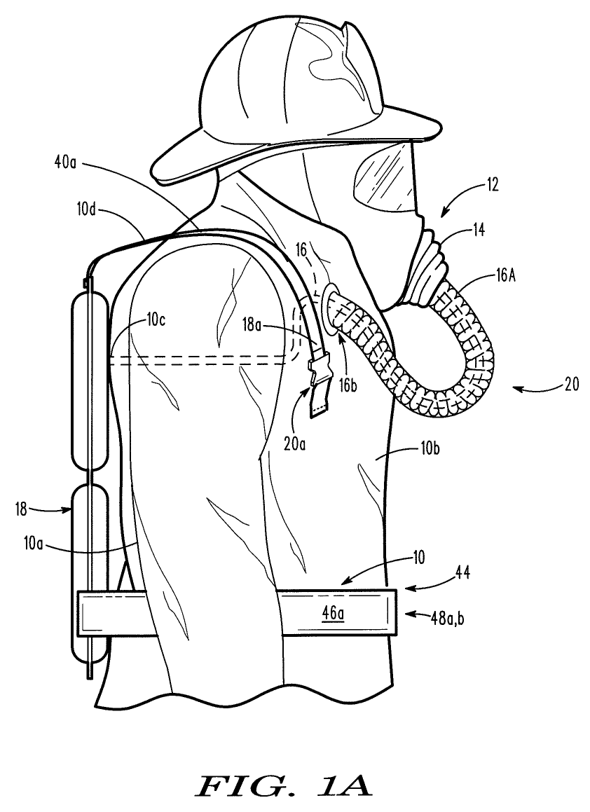

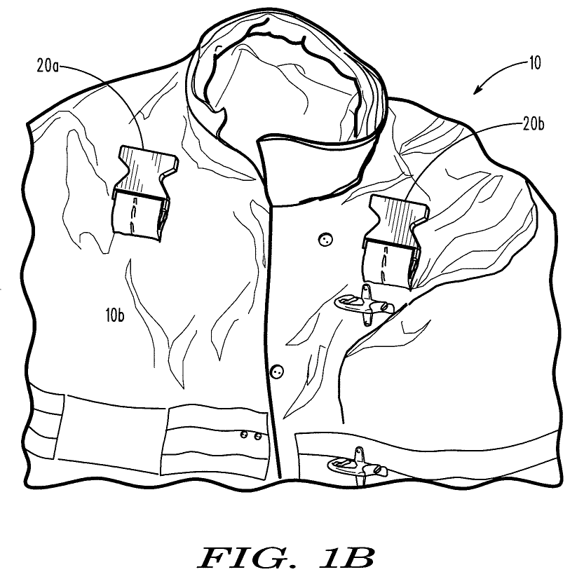

With reference to FIG. 1A, a firefighter or other emergency worker is shown wearing a protective garment in the form of a protective coat 10, and a self-contained breathing apparatus (SCBA) 12 that includes a regulator 14 connected by a high pressure hose 16 to an oxygen/air tank system 18 that is releasibly carried on the back of the firefighter by the coat 10. The tank 18 is located adjacent to a rear surface 10a of the coat 10.

Together, the coat 10 and the SCBA 12 form a system 20 that allows a firefighter or other emergency worker to perform in hazardous environments. Except as described herein, the coat 10 may be substantially similar to prior garments and coats designed for firefighters and rescue workers, such as those manufactured and sold by Morning Pride Manufacturing, Inc. of Dayton, Ohio.

FIG. 1B is a frontal view illustrating a pair of quick release connector elements 20a and 20b which releasibly engage mating connector elements 18a, b carried by tank 18. Connector elements 20a, b are carried on a front surface of 10b of coat 10. Snaplocks, twist locks, snaps or other types of two-part quick release connectors, such as hook and eye, VELCRO brand, connectors can be used and come within the spirit and scope of the invention.

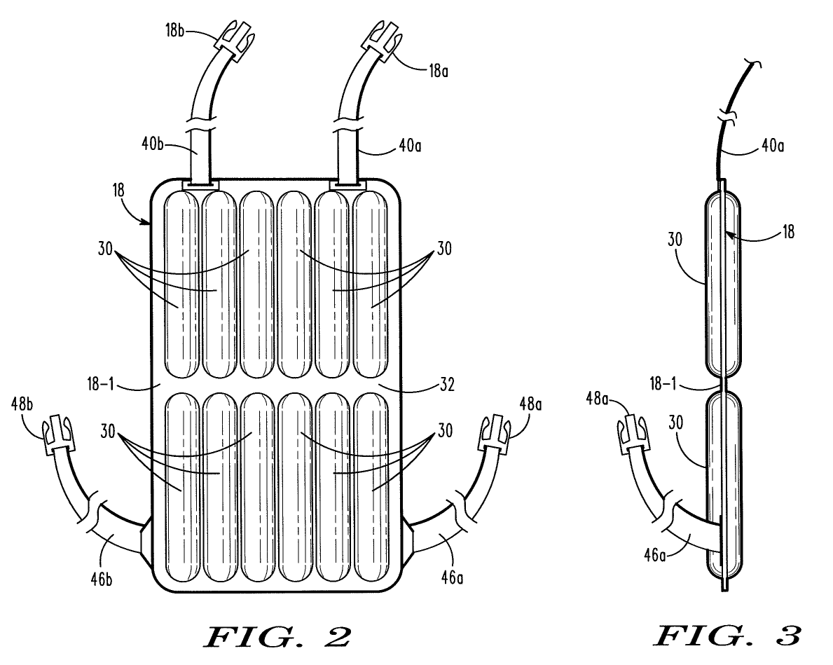

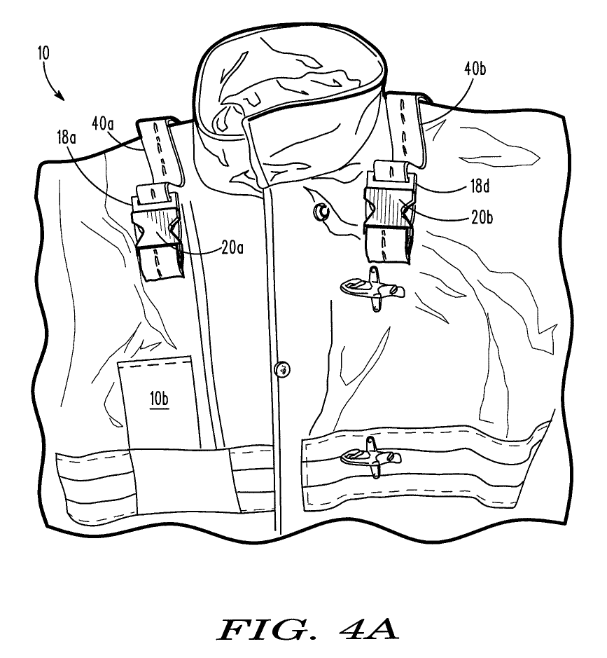

As best seen in FIGS. 2 and 3, the tank system 18 preferably has a lower profile, with a flattened cross-section in comparison to the more conventional cylindrical oxygen/air tanks. In the illustrated embodiment, the tank system 18 has two rows of interconnected, vertically extending, semi-cylindrical oxygen/air compartments or bladders 30 arranged on a substrate 18-1 which could include with a somewhat flexible “hinge” portion 32 that allows the tank to partially conform to and/or bend with the wearer's body. It should be appreciated that while a particular embodiment of the tank system 18 is shown, in some applications it will be desirable use other configurations of tank system 18.

In FIG. 1A a low pressure hose or line 16a extends from an exhalation valve in the regulator 14 to the inside of the coat 10 via the port 16b to direct expelled air from the regulator 14 to the inside of the coat 10 and create a positive pressure therein. As illustrated, the high pressure hose 16 extends inside of the low pressure hose 16a from the coat 10 to the regulator 14. This provides a system 20 wherein there is only one SCBA line or hose exposed on the exterior of the coat 10. A port 10c is provided on the rear 10a of coat 10 through which high pressure hose 16 extends through and couples to tank 18.

The tank system 18 is carried on a substrate 18-1. The bladders 30 are arranged on and carried by the substrate 18-1. Additionally, the substrate 18-1 has connected thereto shoulder straps 40a, b. The shoulder straps 40a, b terminate in the connector elements 18a, b.

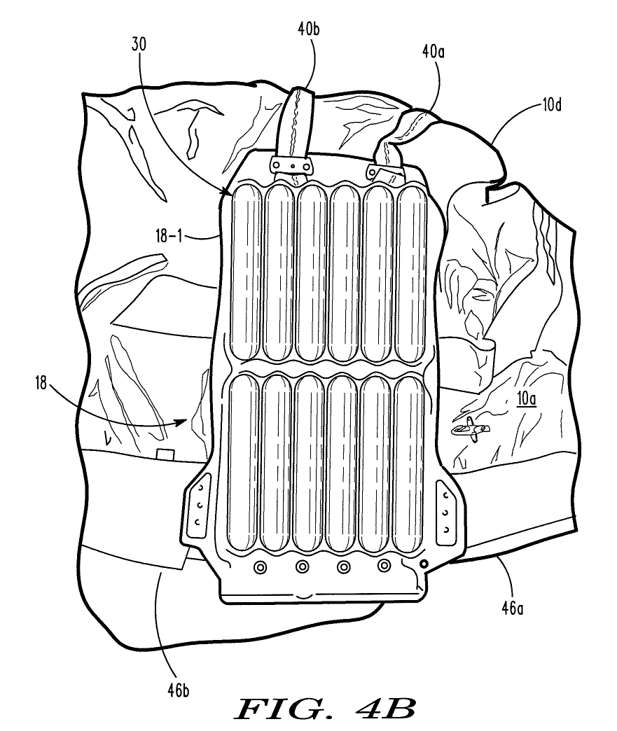

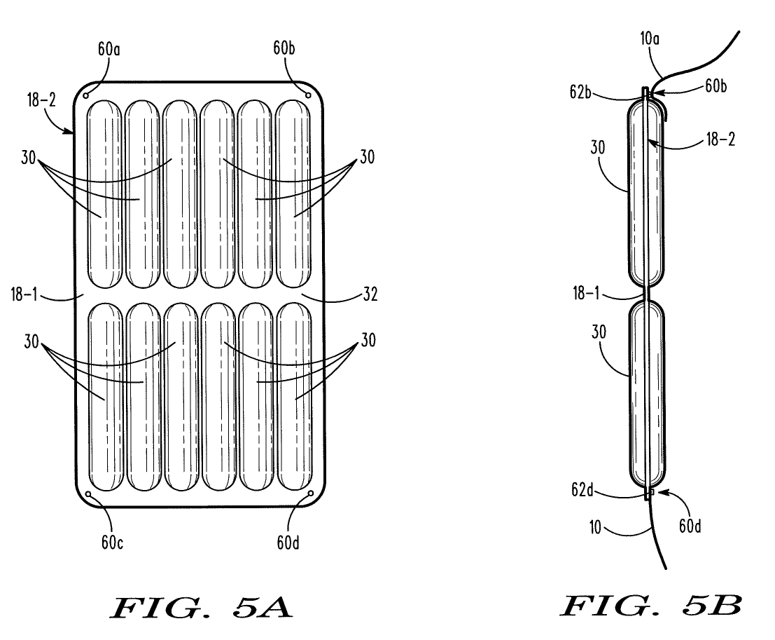

As illustrated in FIGS. 4A, 4B the shoulder straps 40a, b are releasibly coupled to the coat 10 via connector elements 20a, b which are fixedly attached thereto. The substrate 18-1 also carries a waist belt indicated generally at 44 of FIG. 1. The waist belt of 44 has first and second flexible belt portions 46a and 46b each of which terminate in a pair of mating connector elements 48a, b.

The connection of the two elements 46a, 46b around the waist of the first responder on the coat 10 in combination with the elements 40a, b which extend over the first responder's shoulder region 10d provide a secure and comfortable connection of the tank system 18 to the first responder's coat 10.

FIG. 4B illustrates the tank system 18 being carried with the shoulder straps of 40a, b and the waist straps 46a, b by a first responder or firefighter. This configuration provides a relatively flat secure coupling for the tank system 18 adjacent to the back 10a of the firefighter's coat 10.

FIGS. 5A, B illustrate front and side views of a variation 18-2 of the tank system. The system 18-2 carries a plurality of snaps or plastic engaging, hook and eye, fastening elements, such as the VELCRO Brand-type fasteners, 60a, b, c, d. The exact number and location are not limitations of the invention. In this embodiment, the fasteners 60i releasibly engage matching fasteners, such as 62a, b, c, d carried on a rear surface of 10a of the protective garment or coat 10. If desired, this embodiment could also include one or more of straps 40, 46 in addition to the fasteners 60i.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A system comprising:
an oxygen/air tank system;
a regulator;
a high pressure hose connected to the tank system and the regulator to provide a flow of oxygen/air from the tank system to the regulator;
an outer shell having a torso covering portion with a back and a front, a pair of sleeves extending from the torso covering portion; and
first and second connector elements, carried spaced apart on the outer shell, releasibly couplable to the tank system.

2. The system of claim 1 wherein the high pressure hose extends through an opening in a selected surface of the outer shell.

3. The system of claim 2 wherein the high pressure hose extends through a port in the front of the torso covering portion from the interior side of the outer shell to the selected surface of the outer shell.

4. The system of claim 3 further comprising a low pressure line extending from the regulator to inside of the outer shell to direct expelled air from the regulator to inside of the outer shell.

5. The system of claim 4 wherein the low pressure line extends through the port.

6. The system of claim 5 wherein the high pressure line extends inside of the low pressure line from inside of the outer shell to the regulator.

7. The system of claim 1 wherein the tank system has a flattened cross-section.

8. The system of claim 1 where the tank system carries first and second spaced apart shoulder straps.

9. The system of claim 8 where the tank system carries at least one waist strap.

10. The system of claim 9 where the shoulder straps and waist strap each have a free end with the ends each carrying a releasible connector element.

11. The system of claim 10 where the connector elements are selected from a class which includes linearly engagable connector elements, rotatably engagable connector elements, or overlappingly engagable connector elements.

12. The system of claim 10 where the linearly engagable elements comprise snap-lock type connectors.

13. The system of claim 9 where the tank system carries first and second releasibly engagable waist straps.

14. The system of claim 13 where the waist straps each have a free end which carries a waist connector element when the waist connector elements releasibly engage one another.

15. A protective coat for use with a self-contained breathing apparatus system for a firefighter or other emergency worker, the coat comprising:
an outer shell having a torso covering portion with a back and a front;
a pair of sleeves extending from the torso covering portion; and
first and second releasible connector elements fixed to the outer shell and adapted to releasibly carry an oxygen/air tank system of the self-contained breathing apparatus, an opening extending between a first side of the outer shell to allow passage of a high pressure hose of the self-contained breathing apparatus, and a port in a second surface of the outer shell to allow the high pressure hose to pass from the inside of the outer shell to an exterior of the outer shell for connection with a regulator of the self-containing breathing apparatus.

16. The coat of claim 15 which includes a port for a low-pressure hose connection to the regulator.

17. The coat of claim 16 where the low-pressure hose port surrounds the high-pressure hose port.

18. The coat of claim 16 where the connector elements are selected from a class which includes linearly engagable connector elements, rotatably engagable connector elements, or overlappingly engagable connector elements.

19. A coat as in claim 16 which supports the tank on first and second upper shoulder surfaces and where the tank system carries first and second shoulder straps which overlay respective shoulder surfaces and which releasibly engage the connector elements.

20. A coat as in claim 19 where the connector elements are selected from a class which includes linearly engagable connector elements, rotatably engagable connector elements, or overlappingly engagable connector elements.
